(19) United States
(12) Patent Application Publication
(10) Pub. No.: US 2009/0150927 A1
(43) Pub. Date: Jun. 11, 2009

(54) Facilitating interactive advertising in digital television program content through follow-up browsing of selectable advertised offerings presented within such digital television program content

(75) Inventors: Ross Kouhi, Ottawa (CA); Robert Robotham, Ottawa (CA)

Correspondence Address: GALASSO & ASSOCIATES, LP, P.O. BOX 26503, AUSTIN, TX, 78755-0503, US

(73) Assignee: ALCATEL LUCENT

(21) Appl. No.: 11/999,586

(22) Filed: Dec. 6, 2007

(51) Int. Cl. H04N 7/10

(52) U.S. Cl. 725/34

(57) ABSTRACT

A method for facilitating interactive advertising in Digital Television (DTV) program content through highlighting of advertised offerings comprises a plurality of operations. An operation is performed for creating an entry in a buyable item list during presentation of DTV program content. The offering response data structure entry is created in response to selection of a buyable item that is visually highlighted within the DTV program content. An operation is performed for facilitating an order fulfillment process for the selected buyable item in response to the buyable item entry in the buyable item list being selected.

### FIELD OF THE DISCLOSURE

The disclosures made herein relate generally to content and services associated with Digital Television (DTV) formats such as, for example, Internet Protocol Television (IPTV), and more particularly to facilitating interactive advertising in DTV programming content through highlighting of advertised offerings.

### BACKGROUND

Advertising in the context of television programming (i.e., the television advertising model) is typically in the form of commercials. These television commercials are presented during breaks in a particular television show and, thus, are generally referred to as commercial breaks. Presently, production companies include product placements in a given television show. This placement provides an advertiser with exposure to a desired demographic that they feel is relevant to their product and who have a high probability of watching the given television show.

Viewers of television programming routinely find television commercials annoying and disruptive for reasons such as, for example, interruption of desired programming, t offerings that are not of particular interest to a viewer, and the like. As a result, it is well known that viewers ignore television commercials by means such as muting them, changing the channel, leaving the room and the like. To make matters worse, television commercials yield relatively low follow-through to purchase by watchers at least in part because the buying process is decoupled from the advertising process (i.e., the televisions commercials).

Arguably, it can be said and seen that the traditional television advertising model is no longer effective for any number of reasons. One reason is that various digital recording devices weaken the value of television advertisements due to, for example, the ability to skip over them during recording. Another reason is that broadcasters are losing market share and corresponding revenue to various forms of Internet media. Another reason is that viewers are seeing a decrease in the content-to-advert ratio. Still another reason is that avoidance of conventional commercials will always be a key factor in the limited effectiveness of conventional commercials. And, yet another limiting reason is that the efficiency of an advertiser's investment diminishes as ‘push-based’ ads become more annoying to users and modes of avoidance become more effective.

Therefore, interactively facilitating television advertising of various offerings to viewers in a manner that overcomes known drawbacks and limitations of conventional interactive television advertising techniques would be advantageous, desirable and useful.

### SUMMARY OF THE DISCLOSURE

Embodiments of the present invention provide for interactively facilitating television advertising of various offerings to viewers in a manner that overcomes known drawbacks and limitations of conventional interactive television advertising techniques. More specifically, embodiments of the present invention provide for integrated advertisements and presentation of buyable items in a Digital television (DTV) content stream (e.g., an Internet Protocol Television (IPTV) content stream), and allow viewers to select and complete offer fulfillment of such buyable items in a user friendly, non-interruptive manner. Digital Television is defined herein to include program content delivered to a user device (e.g., television) over a network through which digital packets of information are transmitted. Examples of drawbacks and limitations overcome by interactive capability in accordance with embodiments of the present invention include, but are not limited to, interruptive e-commerce functionality that breaks continuity of a viewing experience, being individual-focused such that there is a potential annoyance for group viewing (e.g., a family viewing experience), being reliant upon an awkward, low acuity interface driven from across a room, and interactive e-commerce functionality integral with television program content often being considered a driver of confusion/complexity in a service package.

The present invention overcomes drawbacks and limitations of conventional interactive television advertising techniques in a number of ways. One way is by creating less defined distinctions between advertising and entertainment in the context of television program content. Another way is by presenting offers (e.g., buyable items) to viewers in the context of television program content and in a less overt (i.e., soft sell) approach. The result of overcoming such drawbacks and limitations is achieving a higher efficiency for advertiser investment while keeping viewers satisfied with the overall presentation experience. To this end, embodiments of the present invention will make advertising a source of value rather than of annoyance and viewers will seek it rather than fight it.

In one embodiment of the present invention, a method for facilitating interactive advertising in DTV programming content through highlighting of advertised offerings comprises a plurality of operations. An operation is performed for visually highlighting a selectable advertisement offering presented within DTV program content. The highlighting is performed within presentation of the DTV program content. An operation is performed for creating an entry corresponding to the offering in an offering response data structure during the DTV program content presentation in response to notification of an interest in the offering being transmitted during the DTV program content presentation. The notification being transmitted is facilitated through a DTV infrastructure through which the DTV program content presentation is facilitated. An operation is performed for providing access to offer fulfillment information corresponding to the offering in response to the offering entry in the offering response data structure being selected.

In another embodiment of the present invention, a computer-implemented method for facilitating interactive advertising in DTV programming content through highlighting of advertised offerings comprises a plurality of operations. An operation is performed for creating an entry in a buyable item list during presentation of DTV program content. The buyable item list entry is created in response to selection of a buyable item that is visually highlighted within the DTV program content. An operation is performed for facilitating an order fulfillment process for the selected buyable item in response to the buyable item entry in the buyable item list being selected.

In another embodiment of the present invention, an DTV e-commerce network is configured for visually highlighting a selectable advertisement offering presented within DTV program content, for creating an entry corresponding to the offering in an offering response data structure during the DTV program content presentation in response to notification of an interest in the offering being transmitted during the DTV program content presentation, and for providing access to offer fulfillment information corresponding to the offering in response to the offering entry in the offering response data structure being selected. The highlighting is performed within presentation of the DTV program content. The notification being transmitted is facilitated through a DTV infrastructure through which the DTV program content presentation is facilitated.

In still another embodiment of the present invention, an application server comprises a set of processor-executable instructions. Instructions are provided for facilitating creation of an entry in a buyable item list during presentation of Internet Protocol Television (DTV) program content and instructions are provided for facilitating completion of an order fulfillment process for the selected buyable item in response to the buyable item entry in the buyable item list being selected. The instructions are configured for causing the offering response data structure entry to be created in response to selection of a buyable item that is visually highlighted within the DTV program content.

In yet another embodiment, a computer-implemented method comprises a plurality of operations for facilitating selection of advertisement offerings presented within televised program content dependent upon a preference profile of a viewer of the televised program content. An operation is performed for creating an entry in an offering response data structure during presentation of Digital Internet Protocol Television (DTV) program content. Such offering response data structure entry is created in response to matching a selectable advertisement offering presented within the DTV program content with an interest designated in a preference profile of a viewer of the DTV program content. Thereafter, an operation is performed for providing access to information corresponding to the selectable advertisement offering in response to selecting the offering response data structure entry.

In still yet another embodiment, a computer-implemented method comprises a plurality of operations for allowing deferred initiation of an offer fulfillment process. An operation is performed for televising program content having an advertisement offering presented therein. The advertisement offering can be acted on via a respective offer fulfillment process. During televising of the program content, an operation is performed for creating an entry in an offering response data structure corresponding to at least one of the advertisement offering and a notification reference point associated with the advertisement offering. Thereafter, an operation is performed for accessing offer fulfillment information corresponding to the advertisement offering in response to selecting said offering response data structure entry.

Thus, in practice, embodiments of the present invention allow a viewer of television program content (i.e., a service subscriber) to use a remote control to quickly handoff a follow-up purchase or information link for an item that can be highlighted (e.g., visually highlighted, audibly highlighted, etc) within televised program content. In this manner, a list of general or subscriber-specific buyable items and/or informational offerings is created and the subscriber can subsequently use this list during or after presentation of the televised program content for accessing supplemental information relating to particular buyable items or informational offerings. In one embodiment, a subscriber-specific page at a service provider holds link and screenshot information corresponding to such buyable items and/or informational offerings. The ‘hand-off’ capability allows a viewer to readily select items of interest and to follow-up on associated offer fulfillment information/processes at their discretions (e.g., during or after completion of respective televised program content) using means such as, for example, a web browser, TV-based subscription service, a toll-free voice call or the like.

As can be seen, hand-off capability in accordance with embodiments of the present invention allows an offer fulfillment process (e.g., purchase of a buyable item, accessing more informational details regarding a selected item, etc) to continue in an interactive manner on another platform at a time different than presentation of the televised program content. In essence, selection of a highlighted item causes a deferred interaction which is initiated or ‘bookmarked” during presentation of the televised program content. Advantageously, by storing selected offerings in a viewer retrievable list, such hand-off capability precludes the viewer from having to remember and manually search to find offerings selected during televised program content.

Existing approaches for facilitating interactive advertising and/or offer fulfillment in a TV context rely upon simple menu-driven subscriber shopping services. Conventional product placement is not keyed to meta-data that presents buyables in context. However, use of non-interruptive selection process in accordance with the present invention decouples the purchase closure, making the solution more user friendly. If viewers know that a buying interaction will require them to interrupt their viewing for more than an instant, they will avoid selecting items. To the contrary, interactive advertising and order fulfillment approaches, in accordance with the present invention, provide for a means to select selectable advertisement offerings with a minimum of interruption. Furthermore, interactive advertising and order fulfillment approaches, in accordance with the present invention, enable completion of the purchase process on a computer system (e.g., networked personal computer having a keyboard and visual display), which is an environment more user friendly for typing, for mousing for e-commerce, for electronic storage of receipt information and for local printing.

In some instances, the continual presentation of highlighted selectable advertisement offerings (e.g., buyable items) would be an annoyance to at least some viewers of televised program content viewers in which the highlighted selectable advertisement offerings is being presented. Thus, interactive advertising functionality in accordance with embodiments of the present invention can advantageously allow a user to control the manner in which such highlighted selectable advertisement offerings are being offered and, in doing so, creates an opportunity to provide valuable user features dependent on the functionality that allows the user to control the manner in which such highlighted selectable advertisement offerings are being offered.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 shows a computer-implemented method 100 for facilitating interactive advertising in IPTV programming content through highlighting of selectable advertisement offering in accordance with an embodiment of the present invention.

FIG. 2 shows an IPTV e-commerce network infrastructure in accordance with an embodiment of the present invention, which is suitably configured for carrying out interactive advertising in IPTV programming content through highlighting of selectable advertisement offerings.

### DETAILED DESCRIPTION OF THE DRAWING FIGURES

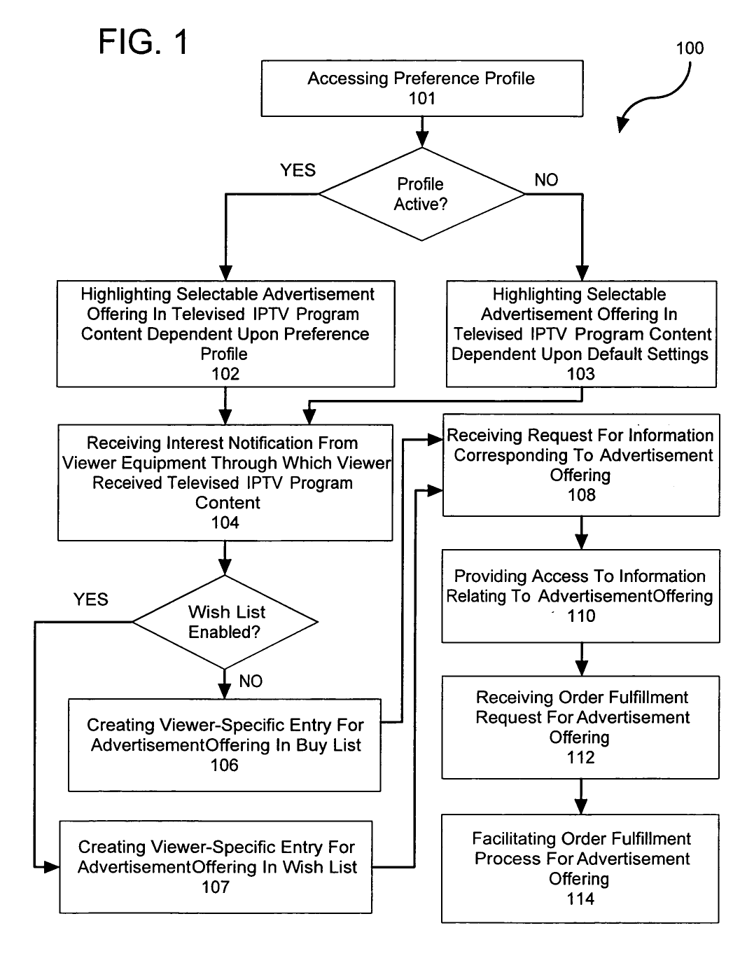

FIG. 1 shows a computer-implemented method 100 for facilitating interactive advertising in IPTV programming content through highlighting of selectable advertisement offering in accordance with an embodiment of the present invention. Examples of selectable advertisement offerings include, but are not limited to, manufactured goods, supplemental program content information, and the like. Thus, embodiments of the present invention are not unnecessarily limited to any particular type or configuration of selectable advertisement offering. In one embodiment, the computer-implemented method 100 can be facilitated by an application server.

The method 100 allows a viewer of television program content (i.e., a service subscriber) to use a remote control to quickly handoff a follow-up purchase or information link for selectable advertisement offerings highlighted (e.g., visually highlighted and/or audibly highlighted) within televised program content. In this manner, a list of subscriber-specific advertisement offerings can be created and the viewer can subsequently use this list during or after presentation of the televised program content for accessing supplemental information relating to a particular buyable items or informational offerings. This ‘hand-off’ functionality allows a viewer to readily select items of interest during televised program content in a manner that is not annoying, distracting or cumbersome, and to follow-up on associated offer fulfillment information/processes at their discretions (e.g., during or after completion of respective televised program content) using means such as, for example, a web browser, TV-based subscription service or the like. The follow-up functionality includes facilitating of an offer fulfillment process (e.g., purchase of a buyable item, accessing more informational details regarding a selected item, etc) in an interactive manner on the same platform as the program content was presented (i.e., IPTV system) or on a different platform (computer system). This follow-up functionality can be performed at any time following an item of interest having been selected. In essence, selection of a highlighted item causes a deferred interaction which is initiated or ‘bookmarked” during presentation of the televised program content.

In some instances, the continual presentation of highlighted selectable advertisement offerings (e.g., buyable items) would be an annoyance to at least some viewers of televised program content viewers in which the highlighted selectable advertisement offerings is being presented. At the same time, some viewers of televised program content would benefit from the highlighting of offerings related to their interests that they might otherwise overlook. Thus, interactive advertising functionality in accordance with embodiments of the present invention can advantageously allow a user to control the manner in which such highlighted selectable advertisement offerings are being offered and, in doing so, creates an opportunity to provide valuable user features dependent on the functionality that allows the user to control the manner in which such highlighted selectable advertisement offerings are being offered. More specifically, through the use of viewer preferences (i.e., a preference profile) stored in an advertisement offering application server, a subscriber system (e.g., set-top box) or other suitable component of an DTV e-commerce network infrastructure, interactive advertising functionality in accordance with embodiments of the present invention allows the behaviour of highlighting functionality, user-response list creation functionality, list interaction functionality and the like can be configured on a user-specific basis.

A skilled person will appreciate that the location where such viewer preferences are stored will at least partially dictate that manner and/or location in which a user is able to invoke (i.e., access) those preferences. In one specific implementation, the preference profile of each user is stored in a set-top box, which limits each user to invoking their respective preference profile on a particular subscriber system. In another specific implementation, the preference profile of each user is stored on an application server (e.g., in a VHO), which allows each user to invoking their respective preference profile on any subscriber system served by that application server. Thus, within the applications server, subscriber preferences can be stored such that movement of viewers between sets on the subscriber premises (or even other subscriber premises) is allowed while preserving controlled access to their preferences (e.g., via a passcode). Alternatively, a less flexible implementation could store preferences in local memory on a set top box, in which case using a different television would not give the viewer access to their preferences.

Following is an exemplary compilation of specific implementations and options (i.e., preferences) for facilitating interactive advertising functionality in accordance with embodiments of the present invention in a manner whereby presentation of highlighted selectable advertisement offerings will cause limited distraction, if any, to a viewer or viewers of televised program content viewers in which the highlighted selectable advertisement offerings are being presented.

Basic Viewer Preference for Advertised Offering Display
Subscriber selectable preference options can be offered to control the selective generation of buyables highlighting. In the most basic sense, such functionality includes a “show no offerings” option and a “show all offerings” option.

Individual Viewer Preferences
While a single (i.e., all or nothing) advertised offering display option can work in many situations, providing for individualized configuration of various advertised offering options (i.e., preferences) will prove useful and advantageous in situations where a single subscriber system is used by a plurality of viewers. Each viewer has the option of creating a personalized preference profile that they can invoke while watching televised program content of their specific interest. For example, in one embodiment, a user invokes their particular preference profile through on-screen selections interacted with using a remote control or buttons of a set-top box. In the most simplistic case, each personalized preference profile can be either a “show no offerings” option or a “show all offerings” option. However, as disclosed below, other more sophisticated, useful and advantageous advertised offering options can be implemented.

Wish-List Creation
Wish list creation functionality causes a selected advertised offering for a viewer to be listed in a “wish-list” of the viewer as opposed to a list that allows then to purchase the advertised offering (i.e., the buy list). Accordingly, this functionality effectively provides an advertised offering option (i.e., preference) of “store selected advertisement offerings in my wishlist”. In one implementation of such wishlist functionality, an entity such as parents, family or friends of a viewer are given access to the viewer's wishlist such that they can view and, if desired, act on advertised offerings that the viewer has added to his or her wishlist (e.g., such as a wishlist of birthday presents, anniversary presents, holiday presents, wedding shower presents, birth shower presents, or the like). Through a wishlist user interface (e.g., an on-screen interface), the viewer or other authorized individual would be able to manage, prioritize and/or access additional information through a web-browser session, TV-based interface or the like. In one embodiment, the wishlist user interface is configured for providing information in a graphical manner with audio descriptions for individuals who cannot sufficiently read textual descriptions.

Interest Matching
Interest matching functionality allows a viewer to specify (e.g., select from one or more lists) subjects of interest such that on-screen highlighting would be selective as opposed to universal. Accordingly, this functionality effectively provides an advertised offering option (i.e., preference) of “show buyables that match with my personal interest profile”.

Such a personal interest profile might contain categories like “hockey”, “computers” and “clothing” or, more specifically, “Designer Clothing”, “Maple Leafs Hockey”, and the like. Programming flow would proceed without any highlighting until advertisement offering conveyance mechanism that accompanies the video stream (e.g., meta-data) describes an item that matches with the viewer's personal interest profile.

Referring to the method 100 as shown in FIG. 1, it is assumed that interactive advertising functionality in accordance with the present invention is active. Otherwise, a viewing experience of televised program content would proceed in a conventional (i.e., prior art) fashion. Accordingly, under the assumption that that interactive advertising functionality in accordance with the present invention is active, an operation 101 is performed for accessing a preference profile of a viewer. In response to such accessing determining that the viewer's preferences is active (e.g., preference profile being manually configured and activated by the viewer), the method 100 continues at an operation 102 being performed for highlighting a selectable advertisement offering in televised IPTV program content in accordance with the viewer's preference profile. For example, in one embodiment, the viewer has configured their preference profile in accordance with one or more of the preferences disclosed above. Otherwise, in response to the viewer's preferences not being active (e.g., non-configured or manually de-activated after being configured), the method 100 continues at an operation 103 being performed for highlighting a selectable advertisement offering in televised IPTV program content in accordance with prescribed default settings. In one implementation of preference profiles, default settings are applied when the viewer's preference profile is not active while interactive advertising functionality in accordance with the present invention is active. In another implementation of preference profiles, default settings are applied (e.g., all available highlighted advertisement offerings are presented) when the viewer's preference profile is enabled but not otherwise manually configured, and the viewing experience of televised program content would proceed in a conventional (i.e., prior art) fashion when the viewer's preference profile is de-activated (e.g., interactive advertising functionality in accordance with the present invention is de-activated).

In the embodiment of the method 100 shown, it is assumed that the viewer's preference profile is accessed only once. In such an embodiment, the viewer's preferences are ‘remembered’ so that actions by the viewer and/or by the method 100 can be implemented in accordance with the viewer's preferences. In other embodiments, the viewer's preference profile is accessed on an as-needed basis to support actions by the user and/or the method 100.

At some point in time after the highlighted advertisement offering is presented (i.e., televised), an operation 104 is performed for receiving an interest notification from viewer equipment through which a viewer receives the televised IP program content. It is disclosed herein that one embodiment of receiving the interest notification includes the interest notification being transmitted by the viewer equipment in response to or after the viewer equipment receives a corresponding signal from a remote control that is configured for transmitting signal to the viewer equipment. For example, in response to the viewer pressing a designated button of the remote control at an appropriate time and/or after having selected the highlighted offering, the viewer equipment (e.g., a set-top box) sends an interest notification for reception by an application server that facilitates interactive advertising functionality in accordance with the present invention. The interest notification includes information relating to an identity of the viewer (e.g., the corresponding viewer equipment), the selected offering, and any other useful/necessary information that is available for doing so.

In response to receiving the interest notification and in response to access of the viewer's preference profile having found that ‘Wish List’ functionality is disabled, an operation 106 is performed for creating a viewer-specific entry for the highlighted advertisement offering in a buyable items list of the viewer. Otherwise, in response to receiving the interest notification and in response to access of the viewer's preference profile having found that ‘Wish List’ functionality is enabled, an operation 107 is performed for creating a viewer-specific entry for the highlighted advertisement offering in a wish list of the viewer. It is disclosed herein that the buyable items list and the wish list are two examples of offering response data structures in accordance with the present invention.

At a point in time after the entry for the highlighted advertisement offering is created in buyable items list or the wish list (i.e., the offering response data structure), an operation 108 is performed for receiving a request for information relating to the highlighted (and selected) advertisement offering. It is disclosed herein that the highlighted advertisement offering can be of various types. Examples of such types include, but are not limited to, a buyable item and an information offering. Thus, the information relating to the advertisement offering can be information relating to a buyable item or information (e.g., supplemental information) relating to respective televised program content. For example, rather than presenting buyable items, a highlighted item—perhaps a bird in a nature program, may be selected to allow viewers to find out additional information immediately or later by the addition to a viewer-specific “tell me more” list.

It is disclosed herein that one embodiment of receiving a request for information relating to the highlighted advertisement offering includes this request being transmitted by the viewer equipment in response to or after the viewer equipment receives a corresponding signal from a remote control that is configured for transmitting signal to the viewer equipment. For example, in response to the viewer selecting a designated on-screen icon or button of a TV system visual display or computer system visual display, the respective system (e.g., computer system or set-top box) sends the request for information relating to the highlighted advertisement offering for reception by an application server that facilitates interactive advertising functionality in accordance with the present invention. The request for information relating to the highlighted advertisement offering includes information relating to an identity of the viewer (e.g., the corresponding viewer equipment), the selected offering, and any other useful/necessary information.

In response to receiving the request for information relating to the highlighted advertisement offering, an operation 110 is performed for providing access to such information. In one embodiment, providing such access includes enabling access through a system and/or infrastructure through which the IPTV program content was televised. In another embodiment, providing such access includes enabling access through a computer network system such as, for example, the World Wide Web and/or Internet (e.g., through a respective website). For assisting the viewer with recalling the content and context in which the highlighted advertising offering was presented, providing access to such information can include displaying an image depicting the highlighted advertising offering in its as-presented context within the associated IPTV program content.

In one embodiment of the present invention (not specifically shown in FIG. 1), in the case of an initial notification request corresponded to multiple advertisement offerings, operation 110 may be performed to provide information to allow the refinement of the notification request to correspond only to the offer(s) of particular interest to the viewer. Thus, in some instances, operation 108 and 110 can be repeated, as needed, following this refinement.

In conjunction with or in response to providing access to such information relating to the highlighted advertisement offering, an operation 112 is provided for receiving an order fulfillment request for the highlighted advertisement offering, followed by an operation 114 being performed for facilitating an order fulfillment process for the highlighted advertisement offering. Facilitating the order fulfillment process allows the viewer to purchase or otherwise obtain the highlighted advertisement offering. For example, in the case of a buyable item, facilitating the order fulfillment process includes taking payment for the buyable item, arranging for shipping of the buyable item, and the like. In the case of an informational offering (e.g., supplemental program content information), facilitating the order fulfillment process includes taking payment for the informational offering, arranging for delivery, checking availability of an item, checking pricing, and the like including the simple display of salient information in text, image or video on the display means of choice. In one embodiment, facilitating the order fulfillment process includes enabling such process to be facilitated via a system and/or infrastructure through which the IPTV program content was televised. In another embodiment, facilitating the order fulfillment process includes enabling such process to be facilitated via a computer network system such as, for example, the World Wide Web and/or Internet (e.g., through a respective website).

It is disclosed herein that one embodiment of receiving an order fulfillment request includes this request being transmitted by the viewer equipment in response to or after the viewer equipment receives a corresponding signal from a remote control that is configured for transmitting signal to the viewer equipment. For example, in response to the viewer selecting a designated on-screen icon or button of a TV system visual display or computer system visual display, the respective system (e.g., computer system or set-top box) sends the order fulfillment request by an application server that facilitates interactive advertising functionality in accordance with the present invention. The order fulfillment request includes information relating to an identity of the viewer (e.g., the corresponding viewer equipment), the selected offering, and any other useful/necessary information.

As disclosed above, the method 100 relies upon selecting a particular highlighted advertisement offering while such highlighted advertisement offering is being presented. Alternatively, the method 100 can be configured in a manner whereby in response to receiving the interest notification at the operation 104, the operation 106 is performed for creating a viewer-specific entry designating a ‘point of the notification’ reference (i.e., notification reference point) in the offering response data structure (e.g., buyable items list, wishlist, etc). The notification reference point includes information allowing a segment of the televised content in which a particular highlighted advertisement offering to be retrieved on-demand. In this manner, the notification reference point entry in the offering response data structure allows the viewer to consider and, optionally, act on the particular highlighted advertisement offering (e.g., facilitate order fulfillment) at a point in time after the viewer initially watched the televised program content in which the particular highlighted advertisement offering was initially viewed. In one implementation, the method 100 can be configured in a manner whereby the operation 108 is performed for receiving a request for information relating to the notification reference point and the operation 110 is performed for providing access to such notification reference point information. For example, providing access to such notification reference point information includes causing the segment of the televised content in which a particular highlighted advertisement offering to be retrieved and re-played (e.g., on a web-browser) and allows the viewer to select one or more highlighted advertisement offerings presented in the segment of the televised content. In this manner, the presentation of selectable advertisement offerings can be presented and selected in a manner that has nominal if not minimal impact of a viewer's viewing experience of televised DTV program content that includes selectable advertisement offerings.

As disclosed above, the method 100 also relies upon advertisement offerings being highlighted such that a viewer can act on such advertisement offerings. Alternatively, the method 100 can be configured such that, as opposed to highlighting selectable advertisement offerings in televised program content, such selectable advertisement offerings are presented in the televised program content without any form of highlighting. As such, selectable advertisement offerings presented in the televised program content are matched to interests of the viewer as specified in the viewer's preference profile. Accordingly, the viewer can thereafter issue a request for information corresponding to advertisement offerings presented in the televised program content and matched to interests of the viewer as specified in the viewer's preference profile, which allows the user to access such information (e.g., via a web browser). In this manner, the viewer can consider and, optionally, act on such matched advertisement offerings at his or her convenience with respect to viewing of the televised program content that included the interest-matched advertisement offerings.

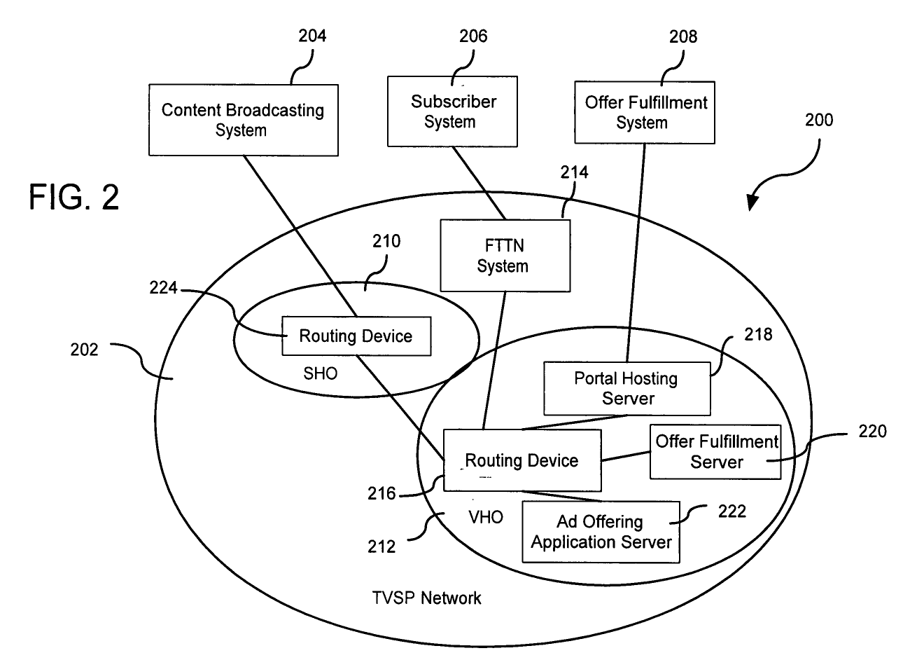

FIG. 2 shows an IPTV e-commerce network infrastructure 200 in accordance with an embodiment of the present invention. The infrastructure 200 is suitably configured for carrying out interactive advertising in IPTV programming content through highlighting of selectable advertisement offerings. For example, in one embodiment, the infrastructure 200 is configured for visually highlighting a selectable advertisement offering presented within (IPTV) program content, for creating an entry corresponding to the offering in an offering response data structure during the IPTV program content presentation in response to notification of an interest in the offering being transmitted during the IPTV program content presentation, and for providing access to offer fulfillment information corresponding to the offering in response to the offering entry in the offering response data structure being selected. The highlighting is performed within presentation of the IPTV program content. The notification being transmitted is facilitated through an IPTV infrastructure through which the IPTV program content presentation is facilitated. A skilled person will appreciate that the IPTV e-commerce network infrastructure 200 is one example of a DTV e-commerce network infrastructure configured in accordance with the present invention, and that the present invention is not limited to one particular type of DTV e-commerce network infrastructure or DTV format (e.g., IPTV).

The infrastructure 200 includes a Television Service Provider (TVSP) network 202, a content broadcast system 204, a subscriber system 206 and an offer processing system 208. In practice, the infrastructure 200 will include a plurality of subscriber systems (only one is shown in FIG. 2 for simplicity). The TVSP network 202 includes a Super Hub Office (SHO) system 210, a Video Hub Office (VHO) system 212 and a Fiber-To-The-Node (FTTN) system 214. The content broadcast system 204 is configured for delivering program content to the TVSP network. It is disclosed herein that program content can be broadcast by any number of means such as, for example, by satellite, by optical fiber, and/or the like. In one embodiment of the present invention, meta-data that encapsulates highlighted advertisement offering information (e.g., perhaps in an MPEG7 format) can be integrated with digital, IP based program content (e.g., within the VHO 212) received from the content broadcast system 204 (which is in MPEG2, MPEG4 or some future multimedia encoding format), thereby allowing the downstream subscriber/viewer to see highlighted advertisement offering (e.g., buyable) items during presentation of such program content.

The subscriber system 206 (e.g., including a set top box and mated remote control) is configured for facilitating presentation of program content to a viewer (i.e., a service subscriber) and for facilitating interactive advertisement offering functionality in accordance with embodiments of the present invention. The offer processing system 208 (e.g., including one or more advertiser application servers) is configured for carrying out processing of advertised offerings for which a subscriber has ordered. To this end, the offer processing system 208 can provide offering information, manage payment transaction tasks, manage shipping tasks and the like. For example, access to a respective viewer-specific entry for a highlighted advertisement offering in an offering response data structure (e.g., entry in a buyable item list) by the viewer (i.e., service subscriber) initiates service interactions (e.g. using WSDL (Web Service Definition Language) and/or SOAP (Simple Object Access Protocol) communication techniques) with vendors to complete the order fulfillment (i.e., purchase) process. Various types and configurations of system configured for broadcasting program content to be televised at subscriber equipment using a computer network system are well known. Similarly, various types and configurations of subscriber systems and offer processing systems are well known.

The VHO system 212 includes a routing device 216, a portal hosting server 218, an offer fulfillment server 220 and an advertisement offering application server 222. The portal hosting server 218, the offer fulfillment server 220 and the advertisement offering application server 222 are each connected to the VHO routing device 216 for enabling interaction therebetween. The offer processing system 208 is connected to the VHO system 212 through the portal-hosting server 218. The subscriber system 206 is connected to the FTTN system 214, which is connected to the VHO system 212 through the VHO routing device 216. The content broadcast system 204 is connected to a routing device 224 of the SHO system 212, which is connected to the VHO system through the VHO routing device 216.

The FTTN system 214 serves as an interface for connectivity between the VHO system 212 and the subscriber system 206. This fibre-to-the-node architecture is merely one means of access technology between the WAN and a residence. The same invention could apply to other delivery schemes, e.g. a copper distribution infrastructure, or even conventional digital broadcast television over the air, while using an internet access link (HSIA or even dialup if you wanted) to perform the signalling back to the network to create the subscriber-specific entries in a web-based interface for later follow-up. One could similarly use a wireless technology for the connection i.e., Wimax or fixed-wireless link.

The SHO routing device 224 (e.g., a router, switch or other type of data unit transmission device) is configured for facilitating reception of data units (e.g., IP packets) carrying broadcast program content by the TVSP network 202 from a broadcaster to the TV program content. In one specific embodiment, for example, an Alcatel-Lucent IP Triple Play server is integrated with the SHO 210, which comprises MPEG4 encoders for facilitating transmission of broadcast TV source feeds and which comprises high bandwidth connections for transferring broadcast program content downstream to the VHO 212. It is disclosed herein that the SHO routing device may receive and/or transmit such data units by any number of means (e.g., via satellite).

The VHO routing device 216 (e.g., a router, switch or other type of data unit transmission device) is configured for facilitating communication of data units (e.g., IP packets) within the VHO system 212. More specifically, the VHO routing device 216 facilitates communication of information between the portal hosting server 218, the offer fulfillment server 220 and the advertisement offering application server 222. In one embodiment, each metro service area supporting interactive advertisement offering functionality in accordance with embodiments of the present invention includes a VHO with an application server 222. It is disclosed herein that the application server 22 may be located outside of a VHO (e.g., located within an SHO).

In one specific embodiment of the embodiment of the TVSP network 202, program content acquired at the SHO 210 and/or the VHO 212 is an IP data packet stream containing MPEG2 or MPEG4 encoded video as well as an MPEG7 metadata stream. Based on user preferences this MPEG 7 stream is ignored at the set-top box, or interpreted at the set-top box to offer buyable highlighting. Variants could allow for MPEG 7 stripping at VHO if user preferences are for no buyables.

The advertising offering applications server 222 captures subscriber events, which indicate an interest in a buyable item, an interest in supplemental information, etc. As disclosed above, such an interest notification can be originated by pressing a button (e.g., a button designated “shop”) on the viewer's remote control. Such expressions of interest would cause the advertised offering to be added to a subscriber specific follow-up list (i.e., an offering response data structure). Advantageously, the subscriber can then later access the follow-up list and proceed to find supplemental information pertaining to the advertised offering (e.g., pricing, purchase information etc), and complete a purchase process through a service provider hosted presentation on either a web-site, an TV-based subscriber service, Personal Digital Assistant (PDA), cell phone, or the like. This multi-screen flexibility is advantageous and provides functionality not found in prior art implementations of interactive advertising in a Televised program content context. When an item on the follow-up list is selected such as when later visiting the service providers web page, the viewer is presented with purchase information and a screen-shot that reminds the viewer of the origin of the event, which initiated the follow-up interest.

The portal hosting server 218 is configured to provide a service provider web presence with subscriber-specific page presentation capability. Such subscriber-specific page presentation capability includes allowing access of advertised offering information and for facilitating offer fulfillment (e.g., as disclosed in reference to operations 110 and 112 of FIG. 1). For example, the functionality of allowing the subscriber to later access the follow-up list and proceed to find supplemental information pertaining to the advertised offering, and to complete the purchase process can be facilitated via the portal hosting server 218.

Referring now to instructions processible by a data processing device, it will be understood from the disclosures made herein that methods, processes and/or operations adapted for carrying out interactive advertising functionality as disclosed herein are tangibly embodied by computer readable medium having instructions thereon that are configured for carrying out such functionality. In one specific embodiment, the instructions are tangibly embodied for carrying out the method 100 and the infrastructure 200 disclosed above. The instructions may be accessible by one or more data processing devices from a memory apparatus (e.g. RAM, ROM, virtual memory, hard drive memory, etc), from an apparatus readable by a drive unit of a data processing system (e.g., a diskette, a compact disk, a tape cartridge, etc) or both. Accordingly, embodiments of computer readable medium in accordance with the present invention include a compact disk, a hard drive, RAM or other type of storage apparatus that has imaged thereon a computer program (i.e., instructions) adapted for carrying out interactive advertising functionality in accordance with the present invention.

In view of the foregoing disclosure, a skilled person will appreciate that methodologies and supporting architectures in accordance with embodiments of the present invention provide for a number of desirable characteristics relative to implementing an advertisement offering solution. One such characteristic is that any required interface for viewers (i.e., service subscribers), advertisers is provided by such supporting architecture. Another such characteristic is that ad production cost is very low (e.g., comparable to building a website using a template plus indicating periods of content/context relevance). Another such characteristic is that use of higher end content is not prevented. Another such characteristic is that anything in program content can be associated with auxiliary content/advertising. More specifically, for example, audio or dialogue as well as visible objects can be highlighted as an offering, the viewer interface does not limit the number of items the viewer can access at any time, bandwidth is only used for ads being accessed as opposed to the sum of available ads, and non-commercial information (e.g., with sponsoring advertising) can be linked to highlighted content. The underlying result is the foundation for considerable increase in the number of advertising opportunities available within given program content.

As disclosed herein, embodiments of the present invention can be implemented using Internet Protocol Television (IPTV) methodologies and infrastructures. It is also disclosed herein that embodiments of the present invention can be implemented using other protocols of delivering television program content to a viewer using a computer network system. Accordingly, the present invention and implementations thereof are not unnecessarily limited to IPTV methodologies and infrastructures.

The US “American's with Disabilities Act of 1990” demands that vendors provide features to assist people with disabilities. In accordance with embodiment of the present invention, access to additional descriptive highlighting, content specific descriptive audio, content specific descriptive text or more complex overlay content could enhance product features for disabled users.

There are known approaches (i.e., prior art) that place advertisements on the screen during the presentation of the program in the form of a “pop-up” (i.e. superimposed on the program content). The advertisements may be targeted based on program content and/or profile information on the viewer. In these solutions, the viewer is able to opt-in or opt-out of seeing these advertisements either in general or based on the advertisement source. In these solutions, if these pop-ups are not presented the information available through them is not available to the viewer. While an important aspect of the present invention is the highlighting of offers of interest to the viewer, the viewer is not limited to selecting offers that have been highlighted during the viewing of the program. If the association of advertisements and other information with aspects of a program becomes ubiquitous then support for multiple simultaneous offers will be required. Known solutions do not appear to have this capability and the mechanisms currently employed if extended to support multiple simultaneous offers could result in a large number of advertisements overlaying the program and each other. Embodiments of the present invention allows for very targeted highlighting of objects that the viewer knows they are interested in ahead of time while still allowing investigation of program elements that the viewer becomes interested in.

Similarly, in such known approaches to embedding buyable information in a program stream, there requires a priori provisioning of the program stream to include integrated advertising events to which a viewer can respond. Thus, with respect to such known approaches, accommodating live events, such as sports or news events cannot be accommodated—the events have not occurred yet, hence assigning endorsement information is impossible. In contrast, in accordance with embodiments of the present invention, viewers can indicate interest in a portion of the content and the associations of buyables or additional information can be assigned later, to be retrieved during the viewer's follow-up step. For example, viewers watching a football game may see a picture of a person in the crowd wearing an item of sports-fan apparel. If many viewers indicate interest at that moment, the broadcaster can note the proliferation of interest events against that moment, and solicit the apparel vendor to provide a commerce opportunity to those viewers. Thus, live-action televised content as well as recorded televised content implemented in combination with interactive advertising functionality in accordance with embodiments of the present invention.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A computer-implemented method, comprising:
highlighting a selectable advertisement offering presented within Digital (DTV) program content, wherein said highlighting is performed within presentation of said DTV program content;
creating an entry corresponding to said offering in an offering response data structure during said DTV program content presentation in response to notification of an interest in said offering being transmitted during said DTV program content presentation, wherein said notification being transmitted is facilitated through an DTV infrastructure through which said DTV program content presentation is facilitated; and
providing access to information corresponding to said offering in response to said offering entry in the offering response data structure being selected.

2. The method of claim 1 wherein:
said offering is for one of a buyable item and a supplemental information relating to said program content; and
at least one of highlighting, creating and providing is performed dependent upon a preference specified in a preference profile.

3. The method of claim 1 wherein said highlighting is performed in response to the selectable advertisement offering corresponding to a category of interests specified in a preference profile.

4. The method of claim 1 wherein highlighting the selectable advertisement offering includes visually highlighting the selectable advertisement offering.

5. The method of claim 1 wherein providing access to said offer information includes enabling said offer information to be accessed through a website.

6. The method of claim 1, further comprising:
facilitating an order fulfillment process for said offering in response to said offer information being accessed.

7. The method of claim 1 wherein:
said interest notification is transmitted from an DTV control unit connected to a television on which said DTV program content is being presented; and
said interest notification is transmitted in response to a designated signal being received by the DTV control unit from a remote control.

8. The method of claim 7 wherein highlighting the selectable advertisement offering includes visually highlighting the selectable advertisement offering.

9. The method of claim 8 wherein:
the offering response data structure includes a buyable items list; and
the entry corresponding to said offering is a buyable item entry corresponding to a buyable item presented within said DTV program content.

10. The method of claim 9 wherein providing access to said offer information includes displaying an image depicting the buyable item in its as-presented context within said DTV program content.

11. The method of claim 10, further comprising:
facilitating an order fulfillment process for said offering in response to said offer information being accessed.

12. The method of claim 11 wherein said highlighting is performed in response to the selectable advertisement offering corresponding to a category of interests specified in a preference profile.

13. The method of claim 1 wherein:
the offering response data structure includes a buyable items list; and
the entry corresponding to said offering is a buyable item entry corresponding to a buyable item presented within said DTV program content.

14. The method of claim 13 wherein providing access to said offer information includes displaying an image depicting the buyable item in its as-presented context within said DTV program content.

15. The method of claim 14, further comprising:
facilitating an order fulfillment process for the buyable item in response to said buyable item entry in the buyable item list being selected.

16. The method of claim 15 wherein providing access to said offer fulfillment information includes enabling said offer information to be accessed through a website.

17. The method of claim 16 wherein said highlighting is performed in response to the selectable advertisement offering corresponding to a category of interests specified in a preference profile.

18. A computer-implemented method, comprising:
creating an entry in a buyable item list during presentation of Digital Television (DTV) program content, wherein said buyable item list entry is created in response to selection of a buyable item that is visually highlighted within said DTV program content; and
facilitating an order fulfillment process for said selected buyable item in response to said buyable item entry in the buyable item list being selected.

19. The method of claim 18 wherein facilitating the order fulfillment process includes enabling offer information to be accessed through a website.

20. The method of claim 18 wherein:
selection of the buyable item is performed by pressing a designated button on a remote control.

21. The method of claim 18 wherein facilitating the order fulfillment process includes displaying an image depicting the buyable item in its as-presented context within said DTV program content.

22. The method of claim 21 wherein:
selection of the buyable item is performed by pressing a designated button on a remote control.

23. The method of claim 22 wherein facilitating the order fulfillment process includes enabling offer information to be accessed through a website.

24. A Digital Television (DTV) e-commerce network configured for:
highlighting a selectable advertisement offering presented within Digital Television (DTV) program content, wherein said highlighting is performed within presentation of said DTV program content;
creating an entry corresponding to said offering in an offering response data structure during said DTV program content presentation in response to notification of an interest in said offering being transmitted during said DTV program content presentation, wherein said notification being transmitted is facilitated through an DTV infrastructure through which said DTV program content presentation is facilitated; and
providing access to offer fulfillment information corresponding to said offering in response to said offering entry in the offering response data structure being selected.

25. The network of claim 24 wherein:
said offering is for one of a buyable item and a supplemental information relating to said program content; and
at least one of highlighting, creating and providing is performed dependent upon a preference specified in a preference profile.

26. The network of claim 24 wherein said highlighting is performed in response to the selectable advertisement offering corresponding to a category of interests specified in a preference profile.

27. The network of claim 24 wherein highlighting the selectable advertisement offering includes visually highlighting the selectable advertisement offering.

28. The network of claim 24 wherein providing access to said offer information includes enabling said offer information to be accessed through a website.

29. The network of claim 24 being further configured for:
facilitating an order fulfillment process for said offering in response to said offer information being accessed.

30. The network of claim 24 wherein:
said interest notification is transmitted from an DTV control unit connected to a television on which said DTV program content is being presented; and
said interest notification is transmitted in response to a designated signal being received by the DTV control unit from a remote control.

31. The network of claim 30 wherein highlighting the selectable advertisement offering includes visually highlighting the selectable advertisement offering.

32. The network of claim 31 wherein:
the offering response data structure includes a buyable items list; and
the entry corresponding to said offering is a buyable item entry corresponding to a buyable item presented within said DTV program content.

33. The network of claim 32 wherein providing access to said offer information includes displaying an image depicting the buyable item in its as-presented context within said DTV program content.

34. The network of claim 33 being further configured for:
facilitating an order fulfillment process for said offering in response to said offer information being accessed.

35. The network of claim 24 wherein:
the offering response data structure includes a buyable items list; and
the entry corresponding to said offering is a buyable item entry corresponding to a buyable item presented within said DTV program content.

36. The network of claim 35 wherein providing access to said offer information includes displaying an image depicting the buyable item in its as-presented context within said DTV program content.

37. The network of claim 36 being further configured for:
facilitating an order fulfillment process for the buyable item in response to said buyable item entry in the buyable item list being selected.

38. The network of claim 37 wherein providing access to said offer fulfillment information includes enabling said offer information to be accessed through a website.

39. An application server, comprising:
instructions for facilitating creation of an entry in a buyable item list during presentation of program content delivered to a viewer through a computer network system, wherein said offering response data structure entry is created in response to selection of a buyable item that is visually highlighted within said program content; and
instructions for facilitating completion of an order fulfillment process for the selected buyable item in response to said buyable item entry in the buyable item list being selected.

40. The server of claim 39 wherein facilitating the order fulfillment process includes enabling offer information to be accessed through a website.

41. The server of claim 39 wherein:
selection of the buyable item is performed by pressing a designated button on a remote control.

42. The server of claim 39 wherein facilitating the order fulfillment process includes displaying an image depicting the buyable item in its as-presented context within said DTV program content.

43. The server of claim 42 wherein:
selection of the buyable item is performed by pressing a designated button on a remote control.

44. The method of claim 43 wherein facilitating the order fulfillment process includes enabling offer information to be accessed through a website.

45. A computer-implemented method, comprising:
creating an entry in an offering response data structure during presentation of Digital Television (DTV) program content, wherein said offering response data structure entry is created in response to matching a selectable advertisement offering presented within said DTV program content with an interest designated in a preference profile; and
providing access to information corresponding to the selectable advertisement offering in response to selecting said offering response data structure entry.

46. The method of claim 45, further comprising:
facilitating an order fulfillment process for said selected advertisement offering in response to said offering response data structure entry being selected.

47. The method of claim 46 wherein facilitating the order fulfillment process includes enabling offer information to be accessed through a website.

48. The method of claim 46 wherein facilitating the order fulfillment process includes displaying an image depicting the buyable item in its as-presented context within said DTV program content.

49. The method of claim 45 wherein facilitating the order fulfillment process includes enabling offer information to be accessed through a website.

50. The method of claim 45 wherein providing said access includes enabling offer information to be accessed through a website.

51. A computer-implemented method, comprising:
televising program content having an advertisement offering presented therein, wherein the advertisement offering can be acted on via a respective offer fulfillment process;
during said televising, creating an entry in an offering response data structure corresponding to at least one of the advertisement offering and a notification reference point associated with the advertisement offering; and
accessing offer fulfillment information corresponding to the advertisement offering in response to selecting said offering response data structure entry.
